(19) United States
(12) Patent Application Publication
(10) Pub. No.: US 2007/0274420 A1
(43) Pub. Date: Nov. 29, 2007

(54) Method and Apparatus for Scanning for Digital Subchannels in a Hybrid Analog/Digital Broadcast

(75) Inventor: William Edwin Billings, Dakota Dunes, SD (US)

Correspondence Address: BRUCE YOUNG, 1024 14TH AVE. SE, LE MARS, IA, 51031, US

(73) Assignee: RADIOSOPHY, LLC, N Sioux City, SD (US)

(21) Appl. No.: 11/696,578

(22) Filed: Apr. 4, 2007

Related U.S. Application Data
(60) Provisional application No. 60/744,204, filed on Apr. 4, 2006.

(51) Int. Cl. H04L 27/06

(52) U.S. Cl. 375/344

(57) ABSTRACT

The present invention is directed to a radio designed to receive both analog and digital subchannels from radio stations that are broadcasting either an analog only signal, a digital only signal, or a hybrid signal containing both analog and digital subchannels. It allows a user to direct the radio to search for either the next active analog or digital subchannel, or alternately to ignore the analog subchannels and search only for digital subchannels. This is accomplished using a single button for either functionality when searching through incrementing frequencies. Another button may be added for decrementing frequencies with the same basic functionality. In the present invention, when the user presses the “Scan Up” button once for a short period of time, the radio will search for the next active analog or digital subchannel above the current location of the virtual channel map. But if the user presses the button twice in quick succession or holds the button down for a longer period of time, the radio will search only for the next digital subchannel above the current location in the virtual channel map.

### CROSS-REFERENCE TO RELATED APPLICATIONS

This application claims benefit of U.S. Provisional Application No. 60/506,707, filed Apr. 4, 2006, entitled “Method and Apparatus for Scanning for Digital Subchannels in a Hybrid Analog/Digital Broadcast,” the contents of which are incorporated herein by reference.

### FIELD OF THE INVENTION

The present invention relates generally to radio and television receiver technology. More specifically, it relates to a method of selecting the desired subchannel from a plurality of subchannels available on a single station.

### BACKGROUND OF THE INVENTION

In the past, radio frequency broadcasts of audio or audio-video programming have used analog technology with a single program per carrier frequency (often referred to as a station). The advent of digital technology provided the capability to offer multiple, simultaneous programs on a single station. Some digital broadcast standards such as the in-band on-channel (IBOC) system developed by iBiquity Digital Corporation for AM and FM radio allow several completely independent, simultaneous programs to be added as digital subchannels to be added to the analog subchannel, combined into a single broadcast signal and sent out in one channel's frequency allocation.

Users have grown accustomed to the model where there is a one-to-one correspondence between the programming and the carrier frequency. For radio broadcasts, they are required to tune to the actual carrier frequency to hear the station; tuning to 90.3 MHz actually sets the tuner to demodulate the carrier at 90.3 MHz. Once a digital carrier with multiple simultaneous programs is broadcast, as allowed by the IBOC standard, the tuning model must be enhanced. While a station frequency is still required, another parameter to select the desired program, or subchannel, from the plurality of programs included in the signal is also required. In the IBOC standard this would allow a station to at 90.3 MHz to have the analog subchannel, the main digital subchannel (HD-1) that usually carries the same audio program as the analog subchannel, and multiple additional subchannels (HD-2, HD-3, . . . HD-7). Most receivers insert the added subchannels as virtual channels between the analog channels. For example, if the user hits the “Tune Up” button while listening to a radio station at 90.3 with three subchannels called main program, HD-2 and HD-3, many IBOC compatible radio receivers will tune from the main program at 90.3 to 90.3 HD-2 and then to 90.3 HD-3 before tuning to 90.5.

Many radios also have a “Scan” functionality that allows the user to tell the radio to find the next active channel instead of requiring the user to manually direct the radio to tune to each possible frequency sequentially. When the “Scan Up” button is pressed on such a radio, the radio will start automatically checking each possible frequency allotment to see if there is an active carrier signal starting from the currently tuned frequency. It will keep incrementing the frequency until it finds an active carrier. It will then stop incrementing the frequency and play the station that it finds. This provides an easy way for the user to rapidly scan through the choices that are available to him. Some radios supporting the IBOC standard add the digital subchannels into their virtual channel map so that if a user is tuned to the radio station at 90.3 MHz described above, hitting the “Scan Up” button causes the radio to change from the main program at 90.3 to 90.3 HD-2 and then to 90.3 HD-3 before starting to scan for an active analog carrier at 90.5 MHz or above. There is no method in existing scan buttons to skip analog subchannels and have the radio scan only for digital subchannels

### SUMMARY OF THE INVENTION

The present invention is directed to a radio designed to receive both analog and digital subchannels from radio stations that are broadcasting either an analog only signal, a digital only signal, or a hybrid signal containing both analog and digital subchannels. It allows a user to direct the radio to search for either the next active analog or digital subchannel, or alternately to ignore the analog subchannels and search only for digital subchannels. This is accomplished using a single button for either functionality when searching through incrementing frequencies. Another button may be added for decrementing frequencies with the same basic functionality. In the present invention, when the user presses the “Scan Up” button once for a short period of time, the radio will search for the next active analog or digital subchannel above the current location of the virtual channel map. But if the user presses the button twice in quick succession or holds the button down for a longer period of time, the radio will search only for the next digital subchannel above the current location in the virtual channel map.

### BRIEF DESCRIPTION OF THE DRAWINGS

FIG. 1 is a block diagram of an exemplary radio broadcast station suitable for generating a signal to be used by the present invention

FIG. 2 is a representation of an exemplary radio receiver capable of utilizing the present invention.

FIG. 3 is a block diagram of a radio receiver utilizing the present invention.

FIG. 4 is a more detailed block diagram of the preferred embodiment of a radio receiver utilizing the present invention.

FIG. 5 is a block diagram of the functions implemented in the firmware running on the Digital Signal Processor in the preferred embodiment of a radio receiver utilizing the present invention.

FIG. 6 is a flow-chart diagram of the present invention.

FIG. 7 is a flow chart diagram of the preferred embodiment of the present invention.

FIG. 8 is a diagram showing the how the two different scanning behaviors would tune through a set of available radio stations.

### DETAILED DESCRIPTION OF THE INVENTION

Reference will now be made to the accompanying drawings to further describe the preferred embodiment of the present invention. While the invention will be described in light of the preferred embodiment, it will be understood that it is not intended to limit the invention to those embodiments. The invention is intended to cover all modifications, alternatives or equivalents which may included within the spirit or scope of the invention as defined by the appended claims.

The following detailed descriptions give many specific details in order to provide a thorough understanding of the present invention. It will be recognized by one of ordinary skill in the art that the present invention may be practiced without those specific details. In other cases, well known methods, processes and techniques have not been described in detail so as not to obscure aspects of the present invention.

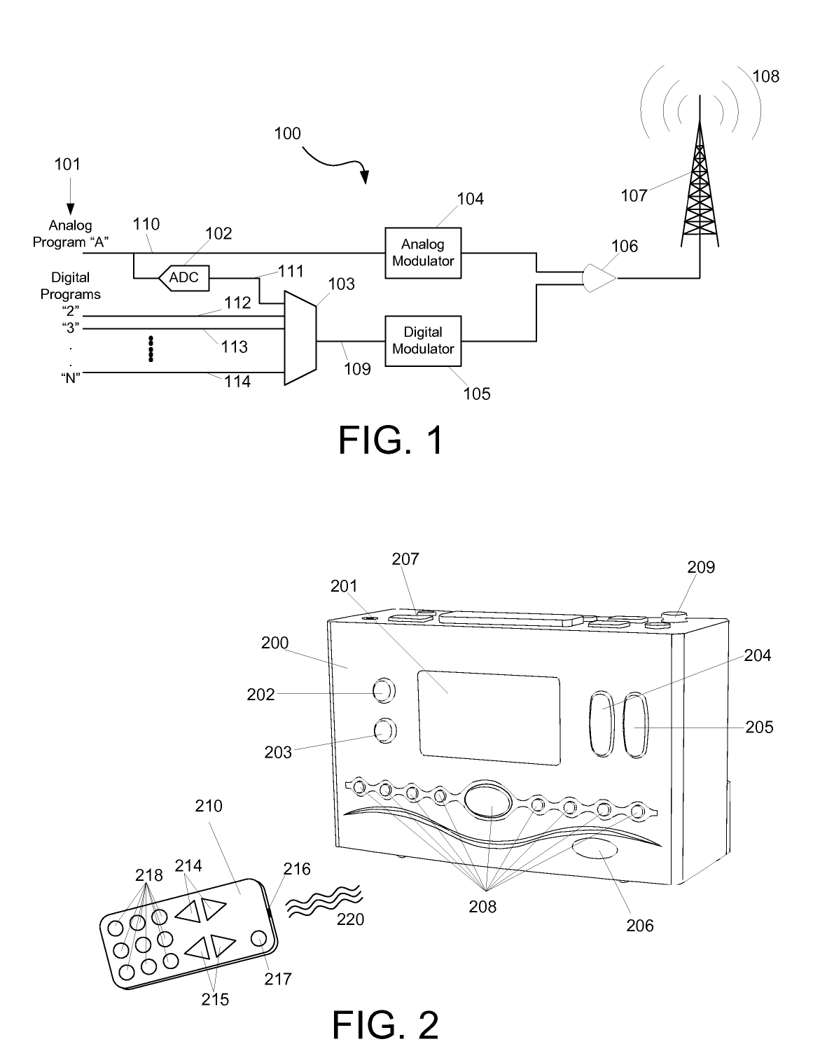

Referring now to FIG. 1, a radio broadcast station 100 is broadcasting a radio signal 108 comprised of several programs 101. These programs 101 can consist of news, sports coverage, talk, music or any other type of audio information. In this particular embodiment which is consistent with the FCC approved in-band on-channel (IBOC) system developed by iBiquity Digital Corporation, there is a single analog audio program “A” 110 that is modulated onto a carrier signal by the analog modulator 104 as the analog subchannel, amplified to a high power signal by the transmitter 106 and broadcast through the antenna 107. In this exemplary embodiment of a radio station 100, the analog modulator 104 uses frequency modulation (FM) on a 87.9 to 109.9 MHz carrier or amplitude modulation (AM) on a 540 to 1700 kHz carrier to generate a signal compatible with readily available AM/FM radio receivers in the United States.

In this embodiment, the analog program “A” 110 is converted to the first digital subchannel 111 by the analog to digital converter (ADC) 102. The main digital subchannel 111 contains the same audio program as analog program “A” 110 but in a digital form. The exemplary radio station 100 can also include additional programs 101 encoded as digital subchannels which are shown in FIG. 1 as digital subchannel “2” 112, digital subchannel “3” 113 and digital subchannel “N” 114. The total number of digital subchannels available on a radio broadcast station 100 may be limited by the particular implementation. The IBOC system allows for up to 8 total digital subchannels to be included on a single station. Further discussion will assume that a station includes three digital subchannels, the main digital subchannel 111, digital subchannel “2” 112 which is sometimes referred to as HD-2 and digital subchannel “3” 113 which is sometimes referred to as HD-3. Digital subchannel “N” 114 is shown to illustrate that more than three digital subchannels may be allowed. These digital subchannels 111-114 can be simple pulse-code modulated (PCM) data or, more commonly, they are compressed using a lossy compression algorithm such as the High Definition Codec (HDC) algorithm used in the IBOC system.

The entire set of digital subchannels 111-114 are then combined into a single digital stream 109 by the multiplexer 103. There are many variations of how the digital subchannels 111-114 can be combined to provide for error robustness and correction but in its simplest form, the multiplexer 103 takes time slices of each digital subchannel 111-114 and combines them into a single, higher-speed, digital stream 109 using time-domain multiplexing. The digital stream 109 is then modulated by the digital modulator 105. In this exemplary embodiment, this modulation is accomplished by using orthogonal frequency domain multiplexing (OFDM) which employs a large number of narrowband subcarriers located in the sidebands of the analog carrier frequency but other technology could be used. The output of the digital modulator 105 is then combined with the output of the analog modulator 104 and amplified by the transmitter 106. The combined signal is then transmitted as the IBOC radio signal 108 by the antenna 107.

While the analog audio program 110 can be recovered from the radio signal 108 by a standard AM/FM receiver simply by tuning the receiver to the proper frequency, additional functionality must be included in the receiver to be able to recover a digital stream. FIG. 2 provides a view of the MultiStream™ HD receiver from Radiosophy as an exemplary receiver 200 capable of an audio program recovered from a digital subchannel in the IBOC radio signal 108. It includes a power switch 207, an antenna 209 for receiving the radio signal 108, a display 201 for identifying the currently selected frequency and other textual information, a button 202 for selecting whether to tune the 540-1700 kHz AM band or the 87.9-107.9 FM band and a button 203 for selecting a menu function in the receiver. It also includes two methods for selecting which frequency to tune. Tuning switch 204 allows the user to step through the selected frequency band to all allowable frequency locations. It will step up or down through the band by 10 kHz steps if the AM band is selected and by 200 kHz steps if the FM band is selected. Scanning switch 205 tells the radio to tune to the next active frequency. It can be rocked up to indicate that the radio should search up through the virtual channel map to find the next active subchannel or it can be rocked down to indicate that the radio should search down through the virtual channel map to find the next active subchannel. The tuning switch 204 and scanning switch 205 will also step sequentially through the available digital subchannels in the IBOC radio signal 108. The radio 200 also includes a set of preset buttons 208. These buttons allow the user to store a frequency and subchannel identifier to be associated with each button allowing the user to rapidly select the same frequency and subchannel in the future.

The radio receiver 200 may also include a remote control 210. This remote control 210 may include a power button 217, tuning buttons 214, scanning buttons 215 and preset buttons 218. It might include other buttons as well. When a button is pressed on the remote control, a specific code sent to the infrared (IR) transmitter 216 causing modulated IR radiation 220 to be emitted. The infrared window 206 on the radio receiver 200 allows the modulated IR radiation 220 to enter the case where it can be received and interpreted. The radio 200 then interprets the specific code to determine which button on the remote control 210 was pressed. It then performs the same action as if the corresponding button on the radio 200 was pressed.

FIG. 3 shows a simplified, high-level block diagram 300 of the radio receiver 200. It includes the antenna 209 that feeds the radio signal 108 to the receiving circuitry 302. The receiving circuitry 302 tunes to the selected frequency, demodulates the signal and feeds it to the demultiplexer (demux) 303. The demux 303 selects desired digital subchannel from the signal based on the selected subchannel and passes it to the amplifier 305 which drives the speaker 306 to generate the audio program for the listener. Control Circuitry 307 can interpret user input from a scan switch 308, and control the receiving circuitry 302, the demux 303 and amplifier 305 to allow the user to select the desired program.

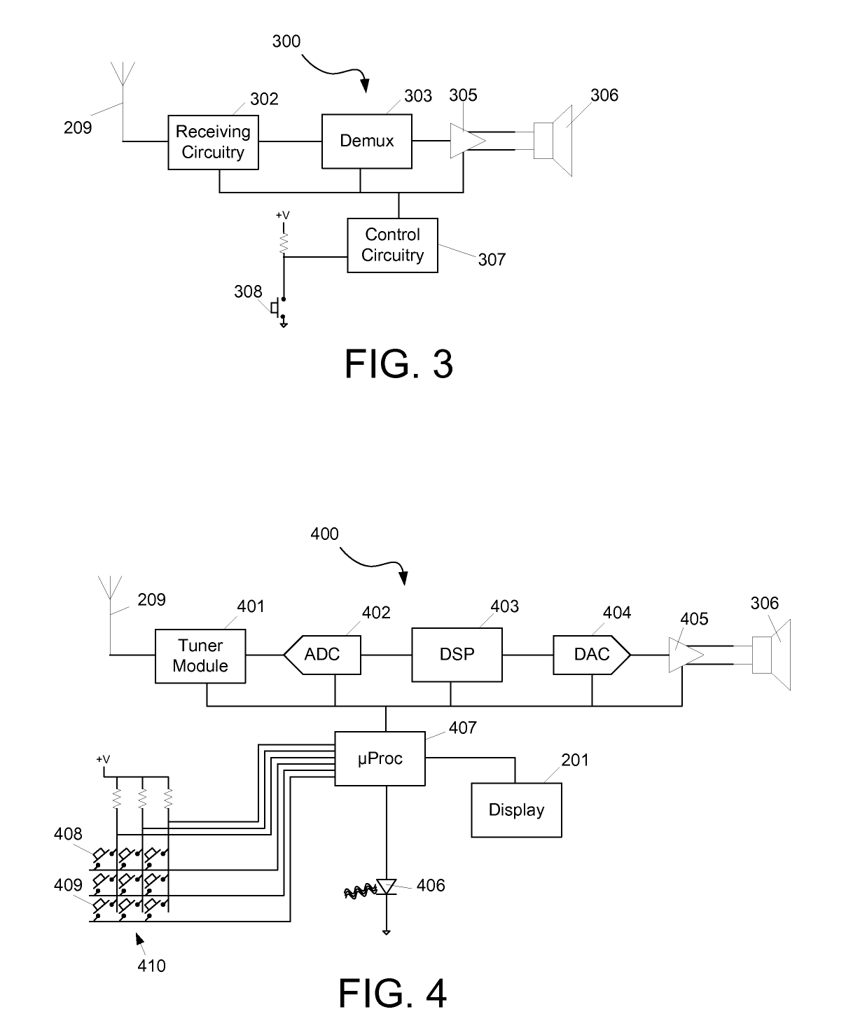

A more detailed block diagram 400 of the preferred embodiment of the radio receiver 200 is shown in FIG. 4. All the elements of the simplified block diagram 300 are present in the detailed block diagram 400 although there is not necessarily a one-to-one correspondence for all the blocks. The receiving circuitry 302 is implemented by the tuner module 401, analog to digital converter (ADC) 402 and firmware running in the digital signal processing subsystem (DSP) 403. The tuner module 401 converts the selected carrier frequency to an intermediate frequency signal that is passed to the ADC 402 where it is digitized before being fed into the DSP 403. The demux 303 is implemented as one of several functions of the firmware in the DSP 403 and the amplifier 305 is comprised of the digital to analog converter (DAC) 404 and analog amplifier 405. Control circuitry 307 is implemented as firmware running in the microprocessor (μProc) 407 and the scan switch 308 is implemented as scan up switch 408 in a switch matrix 410. Block diagram 400 shows some additional detail including a display 201, a scan down button 409 in the switch matrix 410 and an IR receiver 406 that is positioned behind the IR window 206. Scan up and down switches 408 and 409 are the up and down position of the scanning switch 205.

In the preferred embodiment, the tuner module 401 is a TDGA2X010A from Alps Electric Ltd., the ADC 402 is an AFEDRI8201 from Texas Instruments, the DAC 404 is a PCM 1782 from Texas Instruments and the analog amplifier 405 is a TDA8567Q from Philips Semiconductors. The display 201 is a 128×64 dot LCD with backlight such as a BF-MG12864DLBS-19C-1 from Bona Fide Technology Ltd. and the IR receiver 406 is a MIM-5385K1 F from Unity Opto Technology Company Ltd. The DSP 403 is implemented using a TMS320DRI350 Digital Baseband for HD Radio chip from Texas Instruments connected to a 32 Mbit Flash ROM used to store firmware instructions and a 64 Mbit SDRAM to be used for working memory. The μProc 407 is implemented using a PIC18F4550 integrated microcontroller from Microchip Technology Inc. that has 32 kbytes of non-volatile program memory and 2 kbytes of random access memory (RAM). The μProc 407 controls the tuner module 401, the ADC 402, the DSP 403, the DAC 404 and the analog amplifier 405 using combination of dedicated general purpose I/O lines and an I²C bus. The μProc 407 runs software instructions, or firmware, that have been stored in the internal non-volatile program memory allowing it to scan the switch matrix 410 to determine whether scan up switch 408, scan down switch 409, or any other buttons on the radio 200 have been pressed. The firmware running in the μProc 407 can also interpret the output of the IR receiver 406 to determine if a button on the remote control 210 has been pressed. Whenever a scan switch is activated, the μProc 407 detects which button is pressed, and then scans up or down through the virtual channel map by controlling the tuner module 401 and DSP 403.

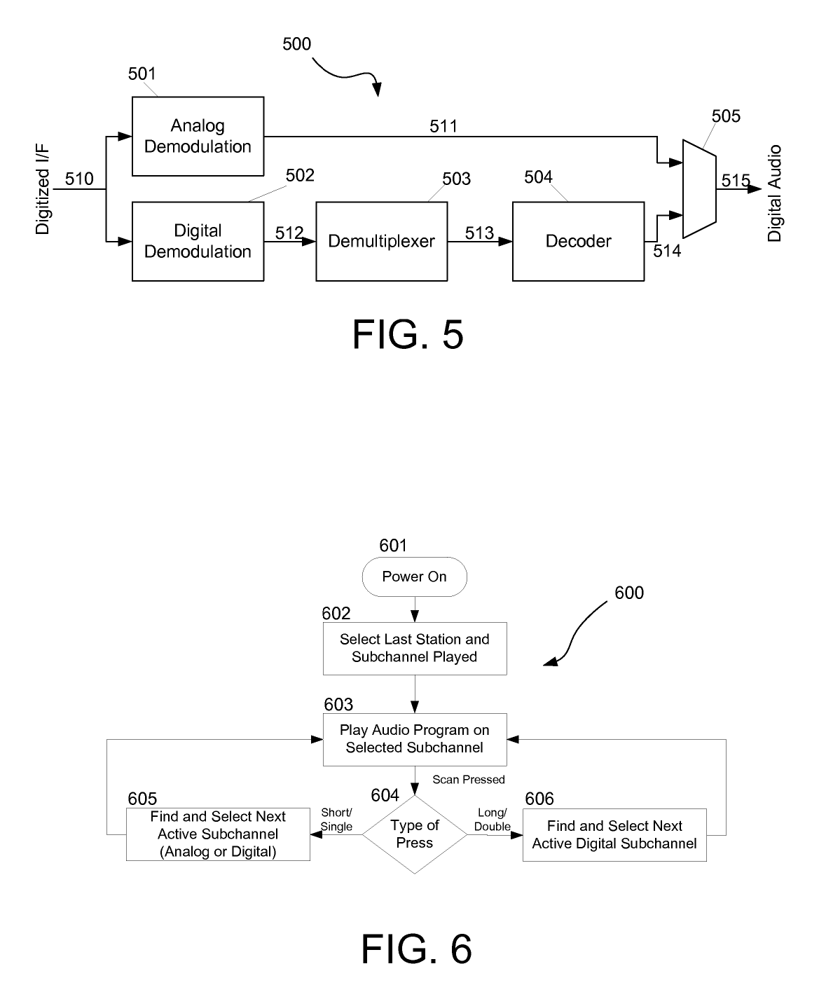

A block diagram of the firmware 500 running on the DSP 403 is shown in FIG. 5. The digitized intermediate frequency data 510 is passed to the analog demodulator 501 firmware block and the digital demodulator 502 firmware block. These blocks perform digital signal processing algorithms on the incoming data 510 to determine if a valid analog and/or digital signal is available. This information is then made available to the μProc 407 to use to decide whether to continue scanning or to stop at the current frequency. If the analog program is to be selected, the analog modulator 501 is commanded to start fully demodulating the incoming data 510 to digital audio data 511 which is then passed to the output selector 505. In the preferred embodiment, the analog demodulator 501 firmware block has the ability to demodulate either an AM or FM signal at the command of the μProc 407. The μProc 407 also commands the output selector 505 to select the digital data 511 representing the analog audio program to be the digital audio output 515 to send to the DAC 404.

If a digital subchannel is to be selected, the μProc 407 commands the digital demodulator 502 to start fully demodulating the digital data 512 from the incoming digitized intermediate frequency data 510. In the preferred embodiment, the digital demodulator 502 firmware block implements an algorithm to extract the digital data 512 from an OFDM signal. The extracted digital data 512 is then passed to the demultiplexer 503 firmware module. The demultiplexer 503 may perform error correction on the data. Then, based on the desired subchannel, the μProc 407 will command it to extract an individual digital subchannel 513 from the demodulated digital data 512. In the preferred embodiment, there is information embedded in the digital data 512 to tag each block of data as being associated with a particular individual digital subchannel. In an alternative embodiment, the individual digital subchannels are simply time domain multiplexed with a pre-determined data block size so that a given data subchannel is made up of a block of “A” bits with “B” bits skipped before the next block of relevant data is found. The exact scheme required is determined by the method used at the broadcast location to multiplex the data and one skilled in the art could apply many different methods to accomplish the same task of extracting an individual digital subchannel 513 from the digital data 512.

If the selected individual digital subchannel 513 consists of compressed audio it will need to be decoded. The decoder 504 firmware block implements the appropriate algorithms to decompress the individual digital subchannel 513 into an uncompressed digital audio stream 514. In the preferred embodiment the decoder 504 implements a the High Definition Coded (HDC) as defined by the IBOC system but many different compression schemes could be used or, if the individual digital subchannels consist of uncompressed PCM audio data, the decoder 504 could pass the data through untouched. The output selector 505 is then commanded to select the uncompressed digital audio stream 514 as the digital audio 515 to send to the DAC 404.

Referring now to FIG. 6, which shows a flow chart 600 of the present invention, the radio 200 is powered on at 601 and it selects the last stations and subchannel played before being turned off at 602 to play again at 603. The radio 200 then waits for a scan command. It determines which type of scan command was received at 604. In the preferred embodiment, the scan command is a press of a scan button 205 and there are two ways that the user may actuate it. The first way is for the user to press it once for less than a predetermined length of time. In the preferred embodiment, the predetermined length of time is one second. If the user presses the scan button 205 in the first way, the radio will search for the next active subchannel of any type and select it at 605. It will then play the audio program contained in that subchannel at 603.

The second way the user can actuate the scan button 205 is to press it twice quickly within the predetermined length of time or to press and hold it for the entire predetermined length of time or some other method to differentiate the second way from the first way. In the preferred embodiment, the user should press the scan button 205 twice within one second to indicate the second way. If the second way is indicated, the radio 200 will search for the next available digital subchannel and select it at 606. It will then play the audio program contained in that subchannel at 603. It should be noted that it may be necessary for the radio to look for the presence of the analog subchannel (or analog carrier frequency) to be able to determine whether to attempt to look for a digital subchannel. The fact that the radio must look for the presence of the analog subchannel does not preclude it from only playing the audio content of the digital subchannels and not subjecting the user to the lower quality content from the analog subchannels.

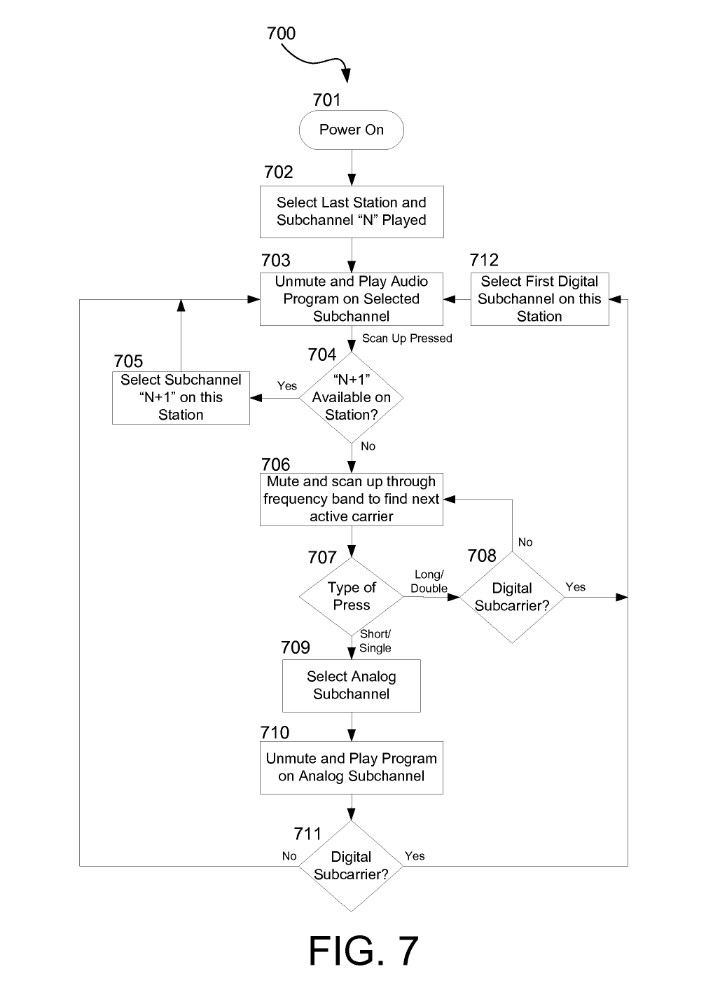

Flow chart 700 in FIG. 7 describes the preferred embodiment in more detail. The radio 200 is turned on at 701 and selects that last station and subchannel “N” played at 702 where “N” refers to a logical subchannel. The logical subchannel can refer to the analog subchannel (N=0), the main digital subchannel (N=1) or other digital subchannels (2≦N≦8 for the IBOC system). It starts to play the audio program from the selected station and subchannel “N” at 703. When the user presses the scan button, the radio will determine if there is a digital carrier containing digital subchannels on the currently selected station and determine whether there is another logical digital subchannel “N+1” available at 704. If there is, it will select subchannel “N+1” at 705 and play the new audio from that subchannel at 703. If there is no digital carrier or if logical subchannel “N+1” is not available on this station when the scan button is pressed, the radio 200 will mute the audio output and begin to search through the possible carrier frequencies at 706 looking for a modulated carrier with enough signal strength to allow it to be received and selects it. When it finds an active carrier signal, it will determine whether the scan was a short single press at 707 indicating that both analog and digital subchannels should be searched. If it is a short single press, the radio selects the analog subchannel of the selected carrier at 709. It then unmutes and plays the audio program at 710. It then looks for a digital subcarrier on the selected frequency at 711 to see if there are any digital subchannels. If there are not, it continues to play the analog subchannel at 703 and waits for the next scan command. If there are digital subchannels available, the radio will switch to the first digital subchannel at 712. This is a standard function within the IBOC system as the first digital subchannel has the same audio program as the analog subchannel and the radio is required to blend over from the analog subchannel to the first digital subchannel automatically to give the user the benefit of the improved sound quality of the digital signal. Once the first digital subchannel has been selected, the radio 200 continues to play the audio at 703 and waits for the next press of the scan button.

If the press of the scan button was not a short single press but was instead a long press or a double-press, the radio 200 will detect this at 707 as an indication that the user wants to find the next available digital subchannel and it should ignore all analog subchannels. It will then look for a digital subcarrier on the newly selected carrier at 708. If it does not find a digital subcarrier, it will start scanning for the next carrier frequency with a strong enough signal to be received at 706. When it finds that next carrier frequency, it will remember that the scan was a digital only scan request at 707 and look for the digital subcarrier again at 708. It will keep doing this until a carrier frequency with a digital subcarrier is found. Once that happens, the radio 200 will select the first digital subchannel on that frequency at 712 and then unmute and play the audio program on that subchannel at 703.

There may also be delays required to allow the radio 200 time to find the next subchannel. There is a finite amount of time required for the radio to evaluate each possible carrier frequency to see if it has a receivable signal and once a receivable signal has been found, additional delays may be required to determine whether a digital subcarrier is available on that station. The delays are not explicitly discussed here as one skilled in the art can determine the exact delay required for the specific implementation.

The possible carrier frequencies to be scanned depends on what type of radio signals are to be received by the radio 200. In the preferred embodiment, the radio can receive either FM signals at a carrier frequency in the range of 87.9 to 109.9 MHz, incrementing by 200 kHz or AM signals with a 540 to 1700 kHz carrier incrementing by 10 kHz. The radio could either scan up or down through the selected frequency range and in the preferred embodiment, has two different scan switches 408 and 409 that can be actuated by rocking the scan button 205 either up or down to let the user indicate which direction to scan. It also will treat the frequency range as a circular range so that if it is scanning up and it hits the top of the range, it will continue to look again from the bottom of the range. It likewise will continue from the top when it hits the bottom if scanning down.

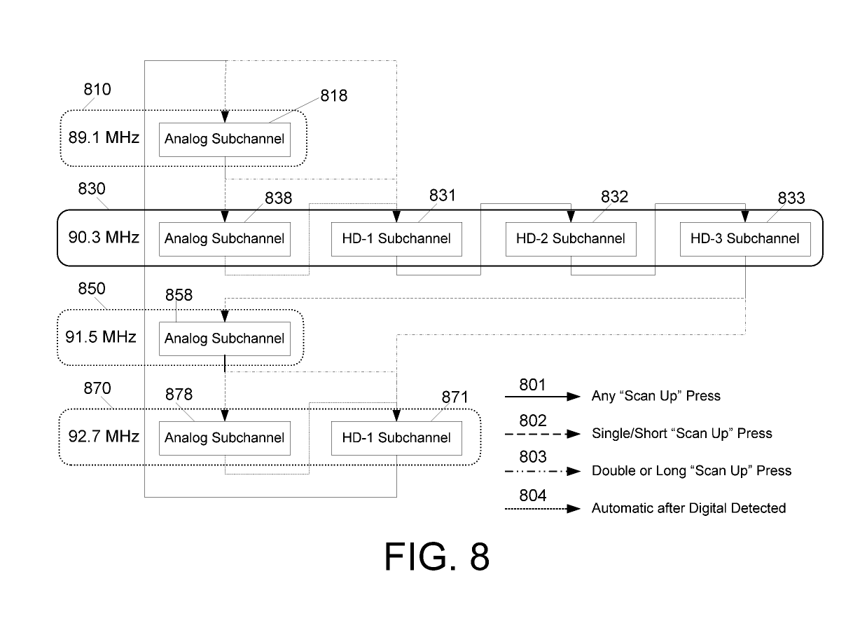

FIG. 8 shows represents for different radio stations and assumes that those four stations are the only stations available to the radio 200. The first station 810 is broadcasting at 89.1 MHz and has an analog subchannel 818 with no digital subchannels. The second station 830 is broadcasting at 90.3 MHz and has an analog subchannel 838, an HD-1 digital subchannel 831 containing the same audio program as the analog subchannel 838, an HD-2 digital subchannel 832 and an HD-3 digital subchannel 833 with different audio programs. The third station 850 is contains a single analog subchannel 858 and is broadcasting at 91.5 MHz and the fourth station 870 is broadcasting at 92.7 MHz with an analog subchannel 878 and a single digital subchannel 871 containing the same audio content.

The differently styled lines indicated the action taken by the radio 200 in response the scan up button being pressed. The radio will automatically switch from the analog subchannel to the first digital subchannel when a digital carrier is detected. This is indicated by arrow of type 804. An example of this transition are changing from the analog subchannel 838 to the HD-1 subchannel 831 of the second station 830. This type of transition occurs automatically with no intervention from the user. If the user presses the scan up button for a single/short press, transitions as shown by line of the type 802 occur. This indicates that the user wishes to go to the next subchannel of either analog or digital. An example of this is the transition from the first station's 810 analog subchannel 818 to the analog subchannel 838 of the second station 830. If the user double-presses the scan up button while listening to the first station's 810 analog subchannel 818, the radio will change to the first digital subchannel 831 of second station 830 as shown by line type 803. In other cases, the radio 200 will select the same next subchannel with either a single or a double press of scan up. This is represented by line type 801 and is shown in the transition from the HD-1 subchannel 831 to the HD-2 subchannel 832 of the second station 830.

The listing below shows the subchannel transitions for a set of single presses of the scan up button if the user starts at the analog subchannel 818 of the first station 810.
First station 810, Analog 818
Second station 830, Analog 838 automatically transitioning to HD-1 831
Second station 830, HD-2 832
Second station 830, HD-3 833
Third station 850, Analog 858
Fourth station 870, Analog 878 automatically transitioning to HD-1 871
First station 810, Analog 818

The listing below shows the subchannel transitions for a set of double-presses of the scan up button is the user starts at the analog subchannel 818 of the first station 810. Note that the radio will not return to the same analog subchannel 818 as the double-press will only to digital subchannels.
First station 810, Analog 818
Second station 830, HD-1 831
Second station 830, HD-2 832
Second station 830, HD-3 833
Fourth station 870, HD-1 871
Second station 830, HD-1 831

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A method of scanning for a next subchannel to be chosen from a plurality of subchannels being broadcast by one or more stations comprising the steps of:
determining a list of possible subchannels that includes all locations where the plurality of subchannels being broadcast by the one or more stations might be found;
determining a subset of the list of possible subchannels;
tuning to a station chosen from the one or more stations and having a currently selected subchannel chosen from the plurality of subchannels;
receiving a scan command;
determining if the scan command is of a first type or of a second type;
scanning through the list of possible subchannels to choose the next subchannel only if the scan command is of the first type; and
scanning through a subset of the list of possible subchannels to choose the next subchannel only if the scan command is of the second type.

2. The method according to claim 1 wherein the first type of scan command is a press of a button for shorter than a predetermined length of time and the second type of scan command is a press of the button for longer than the predetermined length of time.

3. The method according to claim 1 wherein the first type of scan command is a single press of a button and the second type of scan command is two presses of the button within a predetermined length of time.

4. The method according to claim 1 wherein the first type of scan command is a press of a first button and the second type of scan command is a press of a second button.

5. The method according to claim 1 wherein the first type of scan command is a receipt of a first code modulated on an Infra-red signal and the second type of scan command a receipt of a second code modulated on the Infra-red signal.

6. The method according to claim 1 wherein the list of possible subchannels is comprised of locations for both analog subchannels and digital subchannels and the subset of the list of possible subchannels is comprised only of the digital subchannels.

7. The method according to claim 6 wherein the list of possible subchannels is comprised of potential carrier frequencies and a logical subchannel within the carrier frequency for each possible subchannel, the logical subchannel describing either an analog subchannel or one of one or more possible digital subchannels.

8. The method according to claim 7 wherein the potential carrier frequencies is comprised of a list of frequencies from 87.9 MHz to 107.9 MHz separated by 200 kHz or a list of frequencies from or 540 KHz to 1700 kHz separated by 10 kHz.

9. The method according to claim 7 wherein the step of scanning through the list of possible subchannels comprises the steps of:
choosing the next logical subchannel on the currently tuned station as the next subchannel if it exists;
if there is no next logical subchannel available on the currently tuned station, scanning through the potential carrier frequencies contained in the list of subchannels to find a next station with a strong enough signal to tune and selecting the analog subchannel of that station as the next subchannel.

10. An radio for receiving a subchannel selected from a plurality of subchannels being broadcast by one or more stations comprising:
tuning means capable of selecting a single subchannel to be played by the radio;
a first means to change the subchannel;
a second means to change the subchannel;
wherein the radio responds to the first means to change the subchannel by using the tuning means to select a next subchannel from a set of possible subchannels; and
the radio responds to the second means to change the subchannel by using the tuning means to select the next subchannel from a subset of the set of possible subchannels.

11. The radio of claim 10 wherein the first means to change the subchannel is a press of a button for shorter than a predetermined length of time and the second means to change the subchannel is a press of the button for longer than the predetermined length of time.

12. The radio of claim 10 wherein the first means to change the subchannel is a single press of a button and the second means to change the subchannel is two presses of the button within a predetermined length of time.

13. The radio of claim 10 wherein the first means to change the subchannel is a press of a first button and the second means to change the subchannel is a press of a second button.

14. The radio of claim 10 wherein the first means to change the subchannel is a receipt of a first code modulated on an Infra-red signal and the second means to change the subchannel is a receipt of a second code modulated on the Infra-red signal.

15. The radio of claim 10 wherein each subchannel in the set of possible subchannels is identified by a carrier frequency and a logical subchannel within the carrier frequency, the logical subchannel describing either an analog subchannel or one of one or more possible digital subchannels.

16. The radio of claim 15 wherein the set of possible subchannels is comprised of both analog subchannels and digital subchannels and the subset of the set of possible subchannels is comprised only of the digital subchannels.

17. The radio of claim 15 wherein each subchannel in the set of possible subchannels has a carrier frequency in the range of 87.9 MHz to 107.9 MHz or 540 KHz to 1700 kHz and a logical subchannel of analog, digital 1, digital 2, digital 3, digital 4, digital 5, digital 6, digital 7, or digital 8.

18. The radio of claim 15 wherein using the tuning means to select the next subchannel comprises:
selecting a next logical subchannel on the currently tuned frequency as the next subchannel if it exists;
if there is no next logical subchannel available on the currently tuned frequency and the radio is responding to the first means to change the subchannel, scanning through the carrier frequencies of the set of possible subchannels to find a frequency with a strong enough signal to tune and selecting the analog subchannel of that station as the next subchannel.
if there is no next logical subchannel available on the currently tuned frequency and the radio is responding to the second means to change the subchannel, scanning through the carrier frequencies of the set of possible subchannels to find a frequency with a strong enough signal to tune and at least one digital subchannel and selecting a first digital subchannel of that station as the next subchannel.

19. The radio of claim 18 wherein the carrier frequencies of the set of possible subchannels are scanned in the order of ascending frequency.

20. The radio of claim 18 wherein the carrier frequencies of the set of possible subchannels are scanned in the order of descending frequency.
